(19) United States
(12) Patent Application Publication
(10) Pub. No.: US 2012/0157102 A1
(43) Pub. Date: Jun. 21, 2012

(54) Handover Method and Handover Device

(75) Inventors: Yongli Yang, Shenzhen (CN); Zhiming Ding, Shenzhen (CN); Guiming Shu, Shenzhen (CN)

(73) Assignee: HUAWEI DEVICE CO., LTD, Shenzhen (CN)

(21) Appl. No.: 13/407,228

(22) Filed: Feb. 28, 2012

Related U.S. Application Data
(63) Continuation of application No. PCT/CN2010/075544, filed on Jul. 29, 2010.

(30) Foreign Application Priority Data
Aug. 28, 2009 (CN) 200910171407.X
Nov. 20, 2009 (CN) 200910225384.6
Feb. 10, 2010 (CN) 201010116555.4

(51) Int. Cl. H04W 36/00

(52) U.S. Cl. 455/436

(57) ABSTRACT

The present invention discloses a handover method and a handover device. An attachment point is handed over from a service station of a first access network to a handover server of the first access network before a UE hands over from the first access network to a second access network. The handover server of the first access network is interacted with through the tunnel to enter an idle mode of the first access network after completing network access in the second access network. Attachment to a destination station of the first access network is performed to quit the idle mode and re-access the first access network when the UE hands over back to the first access network.

### CROSS-REFERENCE TO RELATED APPLICATIONS

This application is a continuation of International Application No. PCT/CN2010/075544, filed on Jul. 29, 2010, which claims priority to Chinese Patent Application No. 200910171407.X, filed with the Chinese Patent Office on Aug. 28, 2009 and entitled “HANDOVER METHOD AND HANDOVER DEVICE”, Chinese Patent Application No. 200910225384.6, filed with the Chinese Patent Office on Nov. 20, 2009 and entitled “HANDOVER METHOD AND HANDOVER DEVICE”, and Chinese Patent Application No. 201010116555.4, filed with the Chinese Patent Office on Feb. 10, 2010 and entitled “HANDOVER METHOD AND HANDOVER DEVICE”, all of which are incorporated herein by reference in their entireties.

### FIELD OF THE INVENTION

The present invention relates to the field of communications technology, and in particular, to a handover method and a handover device used by a multi-mode user equipment (UE) in a single radio frequency (RF) handover mode.

### BACKGROUND OF THE INVENTION

When a multi-mode UE in a single RF handover mode hands over from one access network to another access network, an appropriate handover server usually needs to be found, and a tunnel between the handover server and the multi-mode UE needs to be established. After authentication and key negotiation are performed between the multi-mode UE and the destination access network through the tunnel, an RF handover is performed, and a network access process is completed on the destination access network.

A handover between Wireless Fidelity (WiFi) and Worldwide Interoperability for Microwave Access (WiMAX) is taken as an example. The WiMAX is a Wireless Metropolitan Area Network (WMAN) access technology, and a signal transmission radius of the WiMAX may be up to 50 km and is substantially capable of covering a suburb. The WiFi is a Wireless Local Area Network (WLAN) access technology, and a signal transmission radius of the WiFi is only hundreds of meters. Both the WiMAX and the WiFi are important wireless broadband access technologies, and have advantages and disadvantages respectively. Using the WiFi as a supplement to the WiMAX in a room where a WiMAX signal is weak or in a populous area is a good option. However, since coverage of the WiFi is small, after handing over to a WiFi access network, the UE may hand over from the WiFi access network back to a WiMAX access network soon.

During the implementation of the present invention, the inventors find that: conventionally, when a UE hands over from a first access network (for example, the WiMAX) to a second access network (for example, the WiFi), and then hands over back to the first access network, an authentication process and a key negotiation process need to be performed again, thereby resulting in a very low efficiency.

### SUMMARY OF THE INVENTION

Embodiments of the present invention provides a handover method and a handover device, so that after handing over from a first access network to a second access network, a multi-mode UE in a single RF handover mode is capable of quickly handing over back to the original first access network.

An embodiment of the present invention provides a handover method, including:

obtaining an address of a handover server of a first access network, when a UE hands over from the first access network to a second access network;

handing over an attachment point of the UE from a service station of the first access network to the handover server of the first access network;

establishing, by the UE, a tunnel with the handover server of the first access network after completing network access in the second access network, interacting with the handover server of the first access network through the tunnel, performing attachment to the handover server of the first access network, and entering an idle mode of the first access network; and

performing, by the UE, attachment to a destination station of the first access network to quit the idle mode and re-access the first access when handing over from the second access network back to the first access network.

An embodiment of the present invention further provides another handover method, including:

obtaining, by a UE, an Internet Protocol (IP) address of a handover server of a first access network;

establishing, by the UE, an IP tunnel with the handover server of the first access network, interacting with the handover server of the first access network through the tunnel, and performing a handover from a service station of the UE to the handover server in the first access network;

entering an idle mode of the first access network from the handover server through the tunnel; and

performing, by the UE, attachment to a destination station of the first access network to quit the idle mode and re-access the first access network when handing over from the second access network back to the first access network.

An embodiment of the present invention provides a handover device, including:

a handover server obtaining unit, configured to obtain an address of a handover server of a first access network when a UE hands over from the first access network to a second access network;

an attachment point handover unit, configured to hand over an attachment point of the UE from a service station of the first access network to the handover server of the first access network;

a handover back preparing unit, configured to establish a tunnel with the handover server of the first access network after the UE completes network access at a second access point (AP), interact with the handover server of the first access network through the tunnel, perform attachment to the handover server of the first access network, and enter an idle mode of the first access network; and

a handover back unit, configured to perform attachment to a destination station of the first access network to quit the idle mode and re-access the first access network when the UE hands over from the second access network back to the first access network.

An embodiment of the present invention provides another handover device, including:

a handover server IP address obtaining unit, configured to obtain an IP address of a handover server of a first access network before or after a UE hands over from the first access network to a second access network;

a re-access handover unit, configured to establish an IP tunnel with the handover server of the first access network after the UE hands over from the first access network to the second access network, re-access the first access network from the handover server of the first access network through the tunnel, and trigger the first access network to hand over an attachment point of the UE from a service station of the first access network to the handover server of the first access network;

an idle mode control unit, configured to interact with the handover server of the first access network through the tunnel after the UE hands over from the service station of the first access network to the handover server of the first access network through the tunnel, and enter an idle mode of the first access network; and

a handover back unit, configured to perform attachment to a destination station of the first access network to quit the idle mode and re-access the first access network when the UE hands over from the second access network back to the first access network.

In view of the technical solutions according to the embodiments of the present invention, after a handover from a first access network to a second access network, a state of a UE in the first access network is set as an idle mode, so that the first access network still keeps context information of the UE after the UE hands over to the second access network. When handing over from the second access network back to the first access network, the UE directly performs attachment to a destination station of the first access network to quit the idle mode and re-access the first access network, thereby completing a handover from the second access network to the first access network. Compared with the prior art, processes such as pre-authentication and key distribution of the first access network do not need to be performed again, and the steps are less, so that after handing over from the first access network to the second access network, the multi-mode UE in the single RF handover mode is capable of quickly handing over back to the original first access network.

### BRIEF DESCRIPTION OF THE DRAWINGS

To illustrate the technical solutions according to the embodiments of the present invention more clearly, the accompanying drawings for describing the embodiments are introduced briefly in the following.

FIG. 1 is a flow chart of a handover method according to an embodiment of the present invention;

FIG. 2 is a complete processing flow chart of a handover method according to an embodiment of the present invention;

FIG. 3 is a flow chart of another handover method according to an embodiment of the present invention;

FIG. 4 is a complete processing flow chart of another handover method according to an embodiment of the present invention;

FIG. 5 is a functional unit diagram of a handover device according to an embodiment of the present invention;

FIG. 6 is a functional unit diagram of a handover device according to another embodiment of the present invention;

FIG. 7 is a flow chart of a third handover method according to an embodiment of the present invention;

FIG. 8 is a complete processing flow chart of the third handover method according to an embodiment of the present invention; and

FIG. 9 is schematic structural diagram of a third handover device according to an embodiment of the present invention.

### DETAILED DESCRIPTION OF THE EMBODIMENTS

The technical solutions in the embodiments of the present invention are clearly and completely described in the following with reference to the accompanying drawings in the embodiments of the present invention.

Currently, a multi-mode UE working in a single RF handover mode gets access to a core network of a first access network through the first access network. When a specified trigger condition is satisfied, the multi-mode UE is required to hand over to an access manner of a second access network, that is, a handover is performed so that the multi-mode UE gets access to the core network of the first access network through the second access network. The specified trigger condition may be that the UE finds that a signal of the first access network is weak, and automatically decides to hand over to the second access network; or a user actively operate a handover of the UE to the second access network; or a network may require a handover of the UE to the second access network.

When the UE hands over from the first access network to the second access network, since the UE works in the single RF handover mode, the UE may turn off an RF of the first access network first, and then turn on an RF of the second access network. This manner is a strict single-receive-single-transmit mode, that is, only one RF circuit is working at any time. The UE may also turn on the RF of the second access network first, and then turn off the RF of the first access network. Before the RF of the first access network is turned off, the RF of the second access network only performs receiving, which indicates a dual-receive-single-transmit mode that also belongs to a single RF working mode. No matter single-receive-single-transmit or dual-receive-single-transmit, once the UE decides to send information through the RF of the second access network, the RF of the first access network needs to be turned off, or at least sending of the RF of the first access network is prohibited. When a terminal hands over from the second access network to the first access network, the process is similar to the preceding.

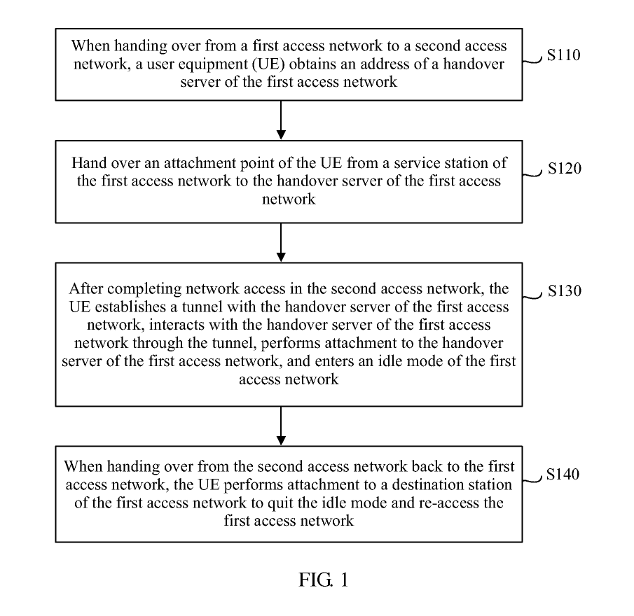

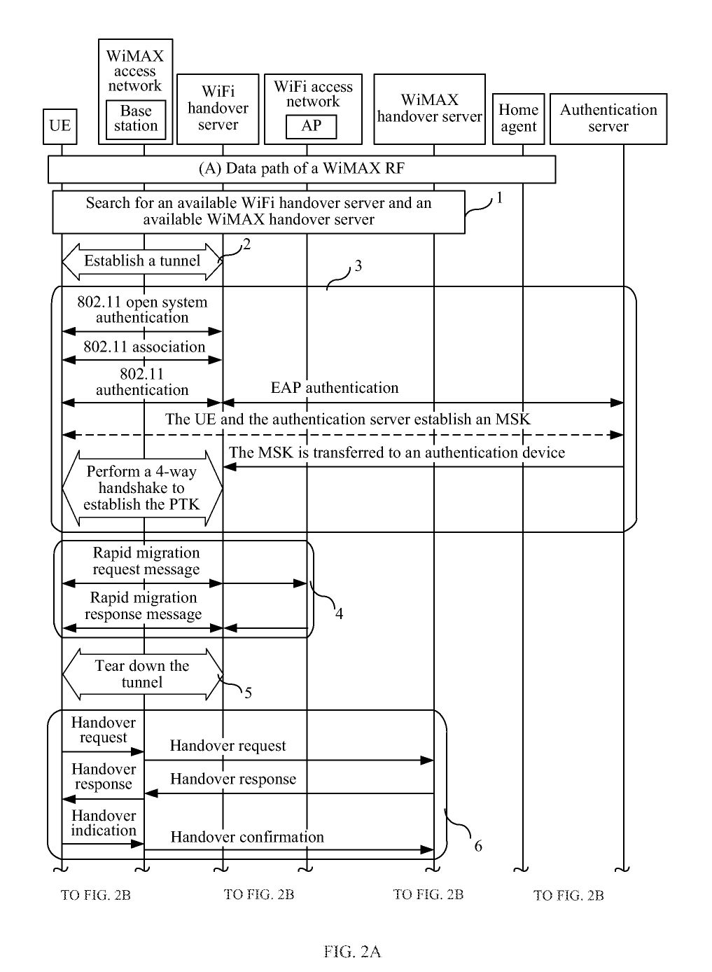

Referring to FIG. 1, a handover method according to an embodiment of the present invention includes:

S110: When handing over from a first access network to a second access network, a UE obtains an address of a handover server of the first access network.

An obtaining method includes, but is not limited to, the following manner: The UE obtains the address of the handover server of the first access network through a Dynamic Host Configuration Protocol (DHCP), or by resolution of a Domain Name System (DNS), or during requesting an IP address in initial network access, or by querying a dedicated information server.

S120: Hand over an attachment point of the UE from a service station of the first access network to the handover server of the first access network.

The attachment point refers to a station that is associated with the UE and provides a service for the UE. For example, when the UE works in WiMAX, the attachment point is a base station to which the UE is registered.

The service station refers to a base station or an AP that communicates with the UE through a wireless RF.

When the first access network is a WiMAX access network, the handing over the attachment point of the UE from the service station of the first access network to the handover server of the first access network includes:

The UE sends a handover request message to a WiMAX service base station and the WiMAX service base station exchanges handover-related information with a WiMAX handover server; the UE receives a handover response message returned by the WiMAX service base station through the service station of the first access network; the UE sends a handover indication message to the WiMAX service base station according to the handover response message and the WiMAX service base station sends a handover confirmation message to the WiMAX handover server.

Here, the WiMAX is taken as an example of the first access network to describe the process of the handover from the WiMAX service base station to the WiMAX handover server, and the WiMAX handover server herein is equivalent to a virtual base station. If the first access network is another network, such as a 3rd Generation Partnership Project (3GPP) access network, a process of a handover of a UE from a service station to a handover server is similar to the preceding, and is not described herein with examples.

S130: After completing network access in the second access network, the UE establishes a tunnel with the handover server of the first access network, interacts with the handover server of the first access network through the tunnel, performs attachment to the handover server of the first access network, and enters an idle mode of the first access network.

Since the attachment point of the UE is already handed over from the service station of the first access network to the handover server of the first access network before the UE completes network access at a second AP, when the UE hands over from the first access network to the second access network, the first access network still keeps context information of the UE, and when the UE hands over from the second access network back to the first access network, processes such as discovery, authentication, and key distribution of the handover server of the first access network do not need to be performed again. Therefore, after completing network access at the second AP, the UE is required only to directly establish a tunnel with the handover server of the first access network, interact with the handover server of the first access network through the tunnel, perform attachment to the handover server of the first access network, and enter an idle mode of the first access network.

Taking that the first access network is the WiMAX access network as an example, after the UE establishes the tunnel with the WiMAX handover server, the WiMAX handover server works as a virtual base station. The UE first performs a ranging process with the virtual base station through the tunnel. The ranging process is the beginning of a WiMAX access process. When completing the ranging, the UE is attached to the virtual base station without the processes such as the authentication and the key distribution. In this case, the UE may send a de-registration request to the virtual base station through the tunnel. After receiving a de-registration response returned by the virtual base station, the UE enters the idle mode. The entering the idle mode aims to prepare for a quick handover of the UE back to a WiMAX RF.

When the UE works in the second access network, in order to keep the idle mode in the first access network, the UE is required to send a message to the handover server of the first access network through the tunnel regularly to keep the UE in the idle mode in the first access network.

The WiMAX network is taken as the example herein. In the WiMAX network, a user terminal keeps the UE in the idle mode by sending a location update message (Location Update) to the network. For another type of network, the idle mode may be kept by sending another message. In another network, the idle mode called in the WiMAX network may also be called a dormant state, an energy saving mode, and so on.

S140: When handing over from the second access network back to the first access network, the UE is attached to a destination station of the first access network to quit the idle mode and re-access the first access network.

This step specifically includes: selecting, by the UE, the destination station of the first access network by detecting or querying; tearing down the tunnel between the UE and the handover server of the first access network; turning off the RF of the second access network, and turning on the RF of the first access network; and performing the ranging process at the destination station of the first access network to quit the idle mode.

Taking that the first access network is the WiMAX access network as an example, under the WiMAX RF, the UE sends a ranging request message to a selected destination base station. In the request message, a parameter is used to indicate the quitting the idle mode, so that network re-accessing is completed through the destination base station. For another type of network, a method for quitting the idle mode is similar to this method, and is not described herein.

In the handover method according to this embodiment of the present invention, when the UE hands over from the first access network to the second access network, the address of the handover server of the first access network is obtained. Before the UE hands over to the second access network, the attachment point of the UE in the first network hands over from the service station to the handover server of the first access network. After the UE hands over to the second access network and completes the network access process in the second access network, the UE establishes the tunnel with the handover server of the first access network, interacts with the handover server of the first access network through the tunnel, perform attachment to the handover server of the first access network, enters the idle mode of the first access network, and then performs attachment to the destination station of the first access network to quit the idle mode and re-access the first access network. Therefore, when the UE hands over to the second access network, the first access network still keeps the context information of the UE. When the UE is required to hand over from the second access network back to the first access network, the RF can be handed over directly, and the UE quits the idle mode at the selected destination station of the first access network to re-access the first access network. Compared with the prior art, the processes such as the pre-authentication and the key distribution of the first access network do not need to be performed again, and the steps are less, so that after handing over from the first access network to the second access network, the multi-mode UE in the single RF handover mode is capable of quickly handing over back to the original first access network.

The preceding embodiment of the handover method according to the present invention is described below through a complete process, in which a UE hands over from a WiMAX access network to a WiFi access network, and then hands over back to the WiMAX access network.

It should be noted that, a handover between the WiMAX and the WiFi is taken only as an example herein. The method according to the present invention is not limited to the handover between the WiMAX and the WiFi, and is also applicable to a handover between a first access network and a second access network of other types.

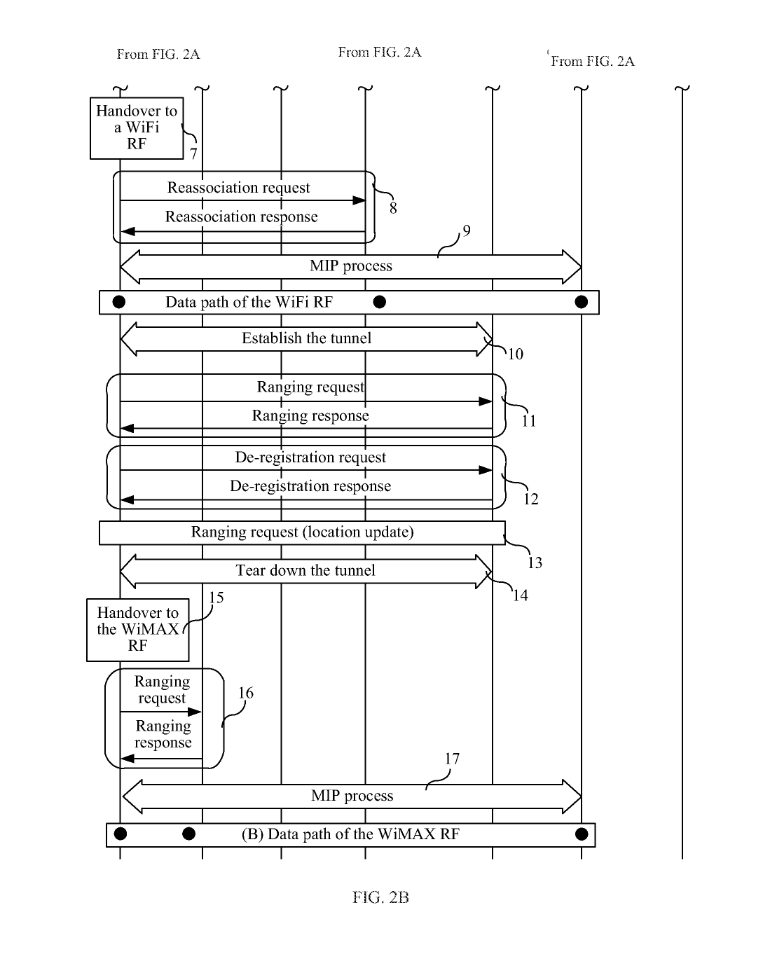

Referring to FIG. 2, the complete process of the handover method according to the embodiment of the present invention includes:

Step 1: A UE searches for an available WiFi handover server and an available WiMAX handover server in a WiMAX Access Service Network (ASN) of the UE. If this process is already completed when the UE initially gets access to the network, the step is not needed herein.

It is assumed herein that the WiFi network also uses a handover server, so that the UE obtains information about the WiMAX handover server and the WiFi handover server at the same time. In fact, whether the WiFi network uses a handover server is not related to the handover method provided in the present invention.

Step 2: Establish a tunnel between the UE and the WiFi handover server.

After the tunnel is established, the WiFi handover server acts as a virtual AP, and a message is transferred between the WiFi handover server and the UE through the tunnel. A data format for the transferring in the tunnel may be: an IP header, a tunnel header (Tunnel header), and an 802.11 MAC (Medium Access Control) frame (802.11 MAC Frame). The IP addresses are an IP address of the WiFi handover server that can be addressed in a public network, and an IP address of the UE. The tunnel header depends on a tunnel protocol to be used, and if a Generic Routing Encapsulation (Generic Routing Encapsulation, GRE) protocol is used, the tunnel header is a GRE header. The 802.11 MAC frames are MAC frames of an 802.11 format that are generated by a WiFi RF module of the UE and the WiFi handover server.

Step 3: The UE completes a process of initially getting access to the WiFi access network at the WiFi handover server (the virtual AP).

First, open system authentication is performed between the UE and the virtual AP. The open system authentication is formed by two messages: The UE sends a request message including an ID of the UE to the virtual AP, and the virtual AP directly returns a success response message. The UE establishes an association with the virtual AP. Then, 802.1x Extensible Authentication Protocol (EAP) authentication is performed between the UE and an authenticatorauthenticator of the WiFi access network. The UE transfers an authentication message to the authenticator of the virtual AP through the tunnel. A Master Session Key (Master Session Key, MSK) is established between the UE and an authentication server. The authentication server transfers the MSK to the authenticator of the virtual AP. A 4-step handshake is performed between the UE and the authenticator of the virtual AP, and a PTK (Pairwise Transient Key) is established authenticator.

Step 4: The UE performs a pre-authentication process with a WiFi AP.

After completing initial network access at the virtual AP, the UE starts to perform the pre-authentication process with the WiFi AP (the destination AP) according to the pre-authentication process in the 802.11-2007 specification. First, the UE uses the PTK that is established by the UE with the authenticator of the virtual AP to send an 802.1X Extensible Authentication Protocol over LAN (Extensible Authentication Protocol over LAN, EAPOL) Start message to the virtual AP. In the MAC frame, a DA (a destination address) is filled with a Basic Service Set Identifier (Basic Service Set Identifier, BSSID) of the destination AP, and an RA (an address of a receiver) is filled with a MAC address of the virtual AP. The virtual AP inquires, according to the BSSID of the DA, an IP address of an authenticator corresponding to the virtual AP. Then, the virtual AP establishes a tunnel with the authenticator of this IP address to exchange authentication data. A result of the pre-authentication is that a Pairwise Master Key Security Alliance (Pairwise Master Key Security Alliance, PMK SA) is established between the UE and the destination AP.

In this process it is assumed that, when a handover from the WiMAX to the WiFi is performed, the pre-authentication is completed through the WiFi handover server first, and then an RF handover is performed. In fact, whether the pre-authentication process of the WiFi network is performed when the handover to the WiFi is performed is not relate to the handover method provided in the present invention.

Step 5: The UE tears down the tunnel between the UE and the WiFi handover server.

Step 6: The UE sends a handover request message to a WiMAX service base station, and hands over to the virtual base station being the WiMAX handover server.

This step is specifically as follows: The UE sends the handover request message to the WiMAX service base station. The WiMAX service base station exchanges handover-related information with the WiMAX handover server. A handover response message returned by the WiMAX service base station is received through the service station of the first access network. The UE sends a handover indication message to the WiMAX service base station according to the handover response message. The WiMAX service base station sends a handover confirmation message to the WiMAX handover server.

This step may be simultaneously performed with a process of Step 2 to Step 5, but the sending, by the UE, the handover indication message to the service base station needs to be performed after Step 5.

Step 7: The UE turns off a WiMAX RF, and turns on a WiFi RF.

Step 8: The UE completes a reassociation process with the destination AP.

A robust security network information element (Robust security network information element, RSNIE) in a Reassociation Request of the UE includes a PMK identifier (PMKID) established in Step 4. After the destination AP finds a PMK corresponding to the PMKID in a buffer of the destination AP according to the PMKID, the two parties perform the 4-step handshake to obtain the Pairwise Transient Key PTK, so that a network access process at the destination AP is completed, that is, a network access process in the WiFi access network is completed.

Step 9: The UE performs a Mobile Internet Protocol MIP registration process.

Step 10: The UE establishes a tunnel with the WiMAX handover server on a WiFi data path.

The tunnel is a three-layer tunnel established with the WiMAX handover server on the WiFi data path. That is to say, the UE exchanges a message with the WiMAX handover server on an IP layer, that is, layer 3 (a link layer is layer 2). A layer 2 message sent by the UE to the WiMAX handover server is transmitted as data in an IP message in the WiFi access network.

Step 11: The UE completes a ranging process with the WiMAX handover server in the tunnel. This step is subsequent to Step 6. After completing the ranging, the UE is attached to the virtual base station.

Step 12: The UE sends a de-registration request to the WiMAX handover server, and enters an idle working mode.

Through the preceding steps, the handover from the WiMAX access network to the WiFi access network is completed, and context information of the UE is kept in the WiMAX access network.

Step 13: When working in the WiFi access network, in order to keep the idle mode of the WiMAX access network, the UE is required to regularly send a Location Update message to the WiMAX handover server through the tunnel.

When the UE decides to hand over back to the WiMAX network, after a handover destination base station is determined, the followings steps are performed:

Step 14: The UE tears down the tunnel between the UE and the WiMAX handover server.

Step 15: The UE turns off the WiFi RF and turns on the WiMAX RF.

Step 16: The UE performs a ranging process and a network re-accessing process at a WiMAX destination base station. This is a process of quitting the idle mode.

Step 17: The UE performs a Mobile Internet Protocol MIP registration process.

In this way, the UE quickly hands over back to the WiMAX access network, so that a current session of a user is kept.

In view of the preceding complete handover process, in the handover method provided in this embodiment, when the UE hands over from the WiMAX access network to the WiFi access network, before the handover, the attachment point of the UE hands over from the WiMAX service base station to the WiMAX handover server, and after the handover from the WiMAX access network to the WiFi access network is completed, the UE is attached to the WiMAX handover server through a WiFi tunnel, and enters the idle mode, so that the WiMAX access network still keeps the context information of the UE. When the UE hands over from the WiFi access network back to the WiMAX access network, processes such as pre-authentication and key distribution of the WiMAX access network do not need to be performed again, the steps are less, so that after handing over from the WiMAX access network to the WiFi access network, a multi-mode UE in a single RF handover mode is capable of quickly handing over back to the original WiMAX access network.

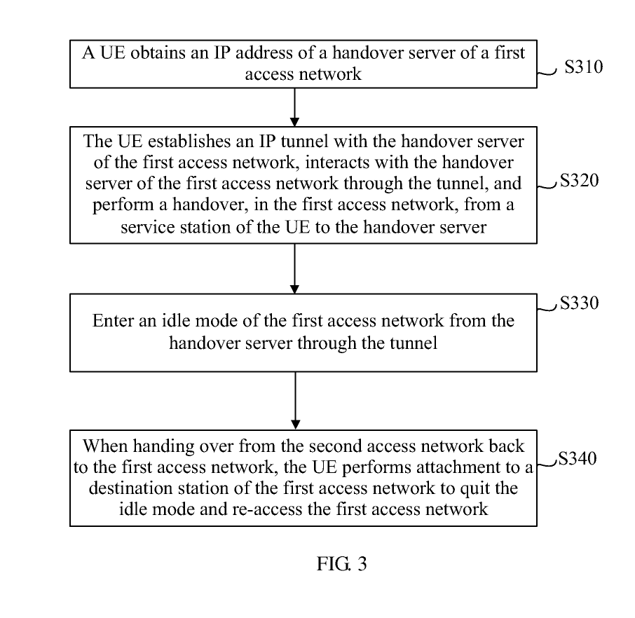

FIG. 3 shows a handover method according to another embodiment of the present invention, including:

S310: A UE obtains an IP address of a handover server of a first access network.

In order to establish an IP tunnel with the handover server of the first access network in a second access network, the UE is required to obtain the IP address of the handover server of the first access network, which may be obtained before an access network handover of the UE, or after the UE hands over to the second access network. Specifically, an obtaining manner may be using a DNS protocol or a DHCP, querying a dedicated information server, and so on, which is not further described herein.

S320: After handing over to the second access network, the UE establishes an IP tunnel with the handover server of the first access network, interacts with the handover server of the first access network through the tunnel, and performs a handover from a service station of the UE to the handover server in the first access network.

The so-called service station refers to an AP of the first access network that serves the UE before the UE hands over to the second access network. For example, if the first access network is the WiMAX, the service station is a base station that originally serves the UE.

Since when handing over from the first access network to the second access network, the UE does not send a message related to the handover to the second access network or related to a request of quitting the first access network in the first access network, the first access network still temporarily keeps context information of the UE. The UE may directly send a handover request to a destination station, for example, the handover server, so that an attachment point is handed over from the service station to the destination station.

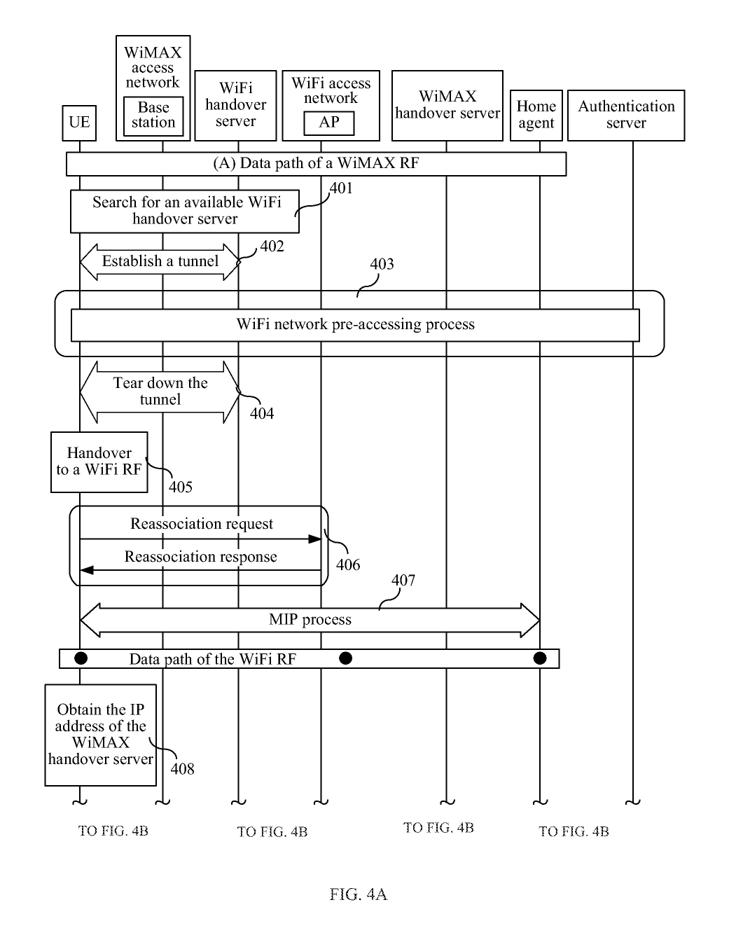

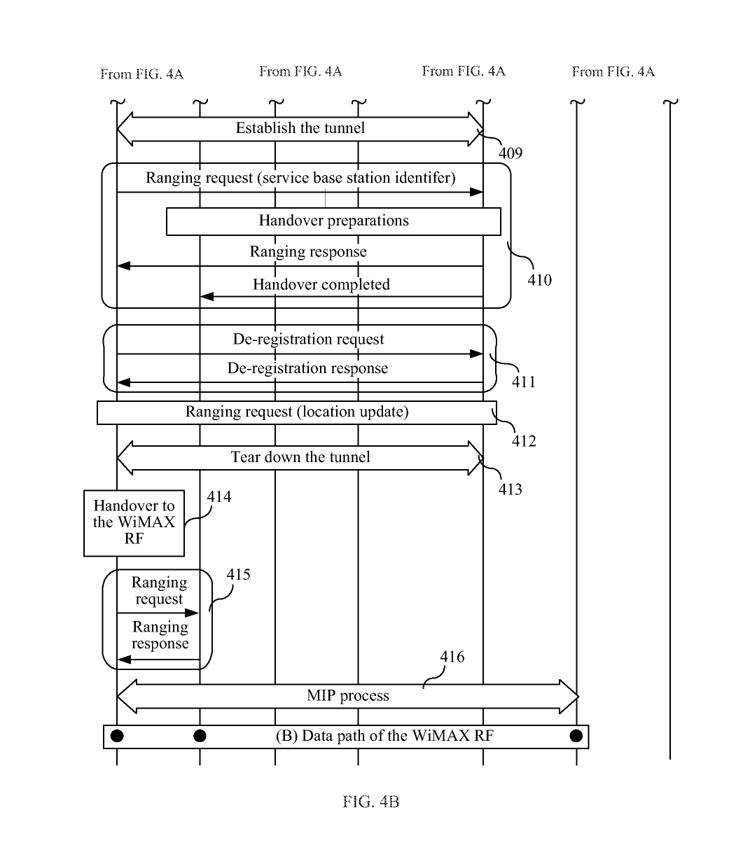

Taking that the first access network is a WiMAX network as an example, the process of the handover of the UE from the service station of the first access network to the handover server of the first access network is as follows: The UE sends a ranging request message to the handover server of the first access network through the tunnel established in the second access network, where the ranging request message includes identification information of the service station of the UE. In this case, an effect of the ranging request sent by the UE is equivalent to that of a handover request. Definitely, the UE may also dedicatedly send a handover request message. Different implementation methods exist in different networks. After receiving the ranging request, the handover server of the first access network obtains the context information of the UE and other information from an access gateway and the service station of the UE (not shown in FIG. 4), and establishes a data path and performs other operations, so that the preparation for the handover is completed. The handover server of the first access network sends a ranging response message to the UE, and indicates that the handover is completed. The handover server of the first access network interacts with the service station of the UE, and confirms that the handover is completed.

Here, the WiMAX is taken as an example of the first access network to describe the process of the handover from the WiMAX service base station to the WiMAX handover server, and the WiMAX handover server herein is equivalent to a virtual base station. If the first access network is another network, such as a 3GPP access network, a process of a handover of a UE from a service station to a handover server is similar to the preceding, and is not described herein with examples.

The present invention does not concern a specific manner in which the tunnel between the UE and the handover server of the first access network is established.

S330: The UE enters an idle mode of the first access network from the handover server through the tunnel.

After the UE completes the handover between base stations of the first access network through Step S320, the attachment point of the UE in the first access network hands over from the original service station of the first access network to the handover server of the first access network, and therefore the UE may enter the idle mode of the first access network from the handover server of the first access network through the tunnel.

Taking that the first access network is the WiMAX access network as an example, the UE sends a de-registration request to the virtual base station through the tunnel between the UE and the handover server of the first access network. The entering the idle mode is indicated in the de-registration request message. After receiving a de-registration response returned by the virtual base station, the UE enters the idle mode of the first access network.

When the UE works in the second access network, if the idle mode in the first access network needs to be kept, a message needs to be regularly sent to the handover server of the first access network through the tunnel to keep the UE in the idle mode in the first access network.

The WiMAX network is taken as the example herein. In the WiMAX network, the UE keeps the UE in the idle mode by sending a location update message (Location Update) to the network. For another type of network, the idle mode may be kept by sending another message. In another network, the idle mode called in the WiMAX network may also be called a dormant state, an energy saving mode, and so on.

S340: When handing over from the second access network back to the first access network, the UE is attached to a destination station of the first access network to quit the idle mode and re-access the first access network.

In an embodiment, this step specifically includes: selecting, by the UE, the destination station of the first access network by detecting or querying; tearing down the tunnel between the UE and the handover server of the first access network; turning off an RF of the second access network, and turning on an RF of the first access network; and performing a ranging process at the destination station of the first access network to quit the idle mode.

Taking that the first access network is the WiMAX access network as an example, under the WiMAX RF, the UE sends a ranging request message to a selected destination base station. In the request message, a parameter is used to indicate the quitting the idle mode, so that network re-accessing is completed through the destination base station. For another type of network, a method for quitting the idle mode is similar to the method, and is not described herein.

In the handover method provided in this embodiment of the present invention, after handing over from the first access network to the second access network, the UE establishes the tunnel with the handover server of the first access network; interacts with the handover server of the first access network through the tunnel; performs the handover from the service station of the UE to the handover server in the first access network; and enters the idle mode of the first access network from the handover server through the tunnel. When handing over from the second access network back to the first access network, the UE performs attachment to the destination station of the first access network, so as to quit the idle mode and re-access the first access network. Therefore, when the UE hands over to the second access network, the first access network still keeps the context information of the UE. When the UE is required to hand over from the second access network back to the first access network, the RF can be handed over directly, and the UE quits the idle mode at the selected destination station of the first access network to re-access the first access network. Compared with the prior art, processes such as pre-authentication and key distribution of the first access network do not need to be performed again, and the steps are less, so that after handing over from the first access network to the second access network, a multi-mode UE in a single RF handover mode is capable of quickly handing over back to the original first access network.

The preceding embodiment of another handover method according to the present invention is described below through a complete process, in which a UE hands over from a WiMAX access network to a WiFi access network, and then hands over back to the WiMAX access network.

It should be noted that, a handover between the WiMAX and the WiFi is taken only as an example herein. The method according to the present invention is not limited to the handover between the WiMAX and the WiFi, and is also applicable to a handover between a first access network and a second access network of another type.

Referring to FIG. 4, a complete process of a handover method according to an embodiment of the present invention includes:

Step 401: A UE searches for an available WiFi handover server.

It is assumed herein that the WiFi network also uses a handover server.

Step 402: Establish a tunnel between the UE and the WiFi handover server.

After the tunnel is established, the WiFi handover server acts as a virtual AP, and a message between the WiFi handover server and the UE is transferred through the tunnel.

Step 403: The UE completes a network pre-accessing process of the WiFi access network at the WiFi handover server (the virtual AP) through the tunnel, and a handover process from the virtual AP to an actual destination AP is included.

In the present invention, since a single RF handover process from the first access network to the second access network is not related to the present invention, the process of the handover from the WiMAX access network to the WiFi access network is not described herein in detail.

Step 404: The UE tears down the tunnel between the UE and the WiFi handover server.

Step 405: The UE turns off a WiMAX RF, and turns on a WiFi RF.

Step 406: The UE completes a reassociation process with the destination AP, and completes re-accessing the WiFi network through an air interface.

Step 407: The UE performs an MIP registration process. After this step is completed, an ongoing application connection of the UE hands over to the WiFi network.

Step 408: The UE obtains an IP address of the WiMAX handover server, for example, by using a DNS or a DHCP, or by querying an information server. This step may also be performed before the UE hands over to the WiFi network. For example, the IP address may also be obtained together with the information about a WiFi Small Form Factor (SFF) in Step 401.

Step 409: The UE establishes an IP tunnel with the WiMAX handover server. Since the UE currently works in the WiFi network, this tunnel passes through the WiFi network.

The tunnel is the IP tunnel. That is to say, the UE exchanges a message with the WiMAX handover server on an IP layer, and a WiMAX air interface message between the UE and the WiMAX handover server is transmitted as data in an IP message.

Step 410: The UE completes a ranging process with the WiMAX handover server in the tunnel, and performs network re-accessing. A ranging request message sent by the UE to the WiMAX handover server includes an ID of a service base station of the UE. After receiving the ranging request message, the WiMAX handover server finds that information about the equipment does not exist; in this case, context information of the equipment is obtained from the service base station of the equipment and other information, such as a new authorization key, is obtained from an access gateway at the same time; in addition, handover preparations such as establishing a path is completed. After completing the preparations, the WiMAX handover server returns a ranging response message to the UE to indicate that the network re-accessing is successful. The WiMAX handover server also sends a handover completion message to the original service base station of the UE. In this case, the original service base station may release the context information of the UE.

Step 411: The UE sends a de-registration request to the WiMAX handover server, and enters an idle working mode.

Through the preceding steps, the handover from the WiMAX access network to the WiFi access network is completed, and context information of the UE is kept in the WiMAX access network.

Step 412: When the UE works in the WiFi access network, in order to keep the idle mode of the WiMAX access network, the UE is required to regularly send a Location Update message to the WiMAX handover server through the tunnel.

When the UE decides to hand over back to the WiMAX network, after a handover destination base station is determined, the followings steps are performed:

Step 413: The UE tears down the tunnel between the UE and the WiMAX handover server.

Step 414: The UE turns off the WiFi RF, and turns on the WiMAX RF.

Step 415: The UE performs a ranging process and a network re-accessing process at a WiMAX destination base station. This is a process of quitting the idle mode. Since the UE is in the idle mode in the WiMAX network when re-accessing the network through the destination base station, the destination base station does not perform the process in Step 409, and is mainly required to establish a data path, thereby resulting in a simple process.

Step 416: The UE performs an MIP registration process.

In this way, the UE quickly hands over back to the WiMAX access network, so that a current session of a user is kept.

In view of the preceding complete handover process, in the handover method provided in this embodiment, after the UE hands over from the WiMAX access network to the WiFi access network, the attachment point of the UE in the WiMAX access network is handed over from the service base station to the WiMAX handover server through the tunnel, and then the idle mode is entered from the WiMAX handover server, so that the WiMAX access network still keeps the context information of the UE. When the UE hands over from the WiFi access network back to the WiMAX access network, the UE may just directly quit the idle mode from the destination base station, processes such as pre-authentication and key distribution of the WiMAX access network do not need to be performed again, and the steps are less, so that after handing over from the WiMAX access network to the WiFi access network, a multi-mode UE in a single RF handover mode is capable of quickly handing over back to the original WiMAX access network.

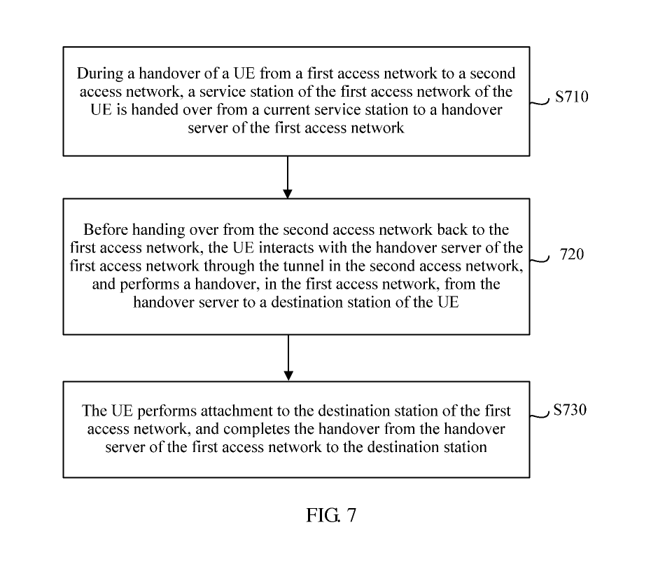

FIG. 7 shows a handover method according to another embodiment of the present invention, including:

S710: During a handover of UE from a first access network to a second access network, a service station of the first access network of the UE is handed over from a current service station to a handover server of the first access network.

The UE may use the embodiment shown in FIG. 1 to perform the process of the handover from the current service station to the handover server of the first access network before the second access network; or use the method in the embodiment shown in FIG. 3 to perform the process of the handover from the current service station to the handover server of the first access network through a tunnel in the second access network after the UE hands over to the second access network.

It is different from the embodiments shown in FIG. 1 and FIG. 3 that, after handing over from the first access network to the second access network, the UE does not enter an idle mode of the first access network.

S720: Before handing over from the second access network back to the first access network, the UE interacts with the handover server of the first access network through the tunnel, performs a handover, in the first access network, from the handover server to a destination station of the UE.

In this step, the UE requests a first access server for a handover to the destination station through the tunnel that passes through the second access network, and the destination station completes preparations for the handover.

S730: The UE performs attachment to a destination station of the first access network, and completes the handover from the handover server of the first access network to the destination station. In this step, the UE hands over to the first access network at an air interface, and is attached to the destination station that makes the preparations for the handover ahead. The destination station completes a subsequent step of the handover from the handover server of the first access network to the destination station. After this step is completed, the handover from the second access network to the first access network is thoroughly completed.

In the handover method provided in this embodiment of the present invention, during the handover of the UE from the first access network to the second access network, the service station of the first network of the UE is handed over from the current service station to the handover server of the first access network. Before handing over from the second access network back to the first access network, the UE interacts with the handover server of the first access network through the tunnel, and performs the handover, in the first access network, from the handover server to the destination station of the UE. The UE performs attachment to the destination station of the first access network, and completes the handover from the handover server of the first access network to the destination station. Therefore, when the UE hands over to the second access network, the first access network still keeps context information of the UE. When being required to hand over from the second access network back to the first access network, the UE hands over from the handover server of the first access network to the destination station through the tunnel, thereby completing the process of the handover back to the first access network. Compared with the prior art, processes such as pre-authentication and key distribution of the first access network do not need to be performed again, and the steps are less, so that after handing over from the first access network to the second access network, a multi-mode UE in a single RF handover mode is capable of quickly handing over back to the original first access network.

The preceding embodiment of another handover method according to the present invention is described below through a complete process, in which a UE hands over from a WiMAX access network to a WiFi access network, and then hands over back to the WiMAX access network.

It should be noted that, a handover between the WiMAX and the WiFi is taken only as an example herein. The method according to the present invention is not limited to the handover between the WiMAX and the WiFi, and is also applicable to a handover between a first access network and a second access network of another type.

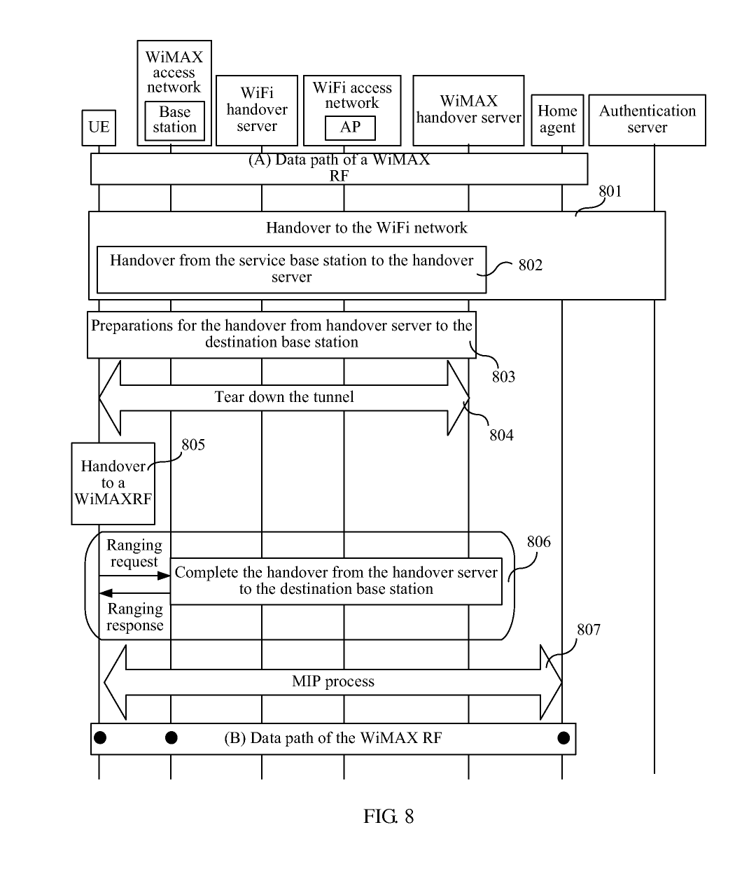

Referring to FIG. 8, a complete process of a handover method according to an embodiment of the present invention includes:

Step 801: A UE hands over from a WiMAX access network to a WiFi access network. This step is already described in detail in the embodiments shown in FIG. 2 and FIG. 4, and is not described herein again.

Step 802: During the handover from the WiMAX access network to the WiFi access network, the UE completes a handover from a WiMAX service base station to a WiMAX handover server. This process may use the method illustrated in Steps 6 and 11 in the embodiment shown in FIG. 2 or the method illustrated in Step 410 in the embodiment shown in FIG. 4. The method in Steps 6 and 11 shown in FIG. 2 is as follows: Before handing over to the WiFi access network, the UE requests the WiMAX service base station for the handover to the WiMAX handover server; the WiMAX service base station and the WiMAX handover server complete preparations for the handover; then, the UE confirms performing of the handover to the WiMAX service base station; after handing over to the WiFi access network, the UE is attached to the WiMAX handover server through a tunnel, and completes the handover from the service base station to the handover server. In the method illustrated in Step 410 in FIG. 4, when the UE is attached to the WiMAX handover server through the tunnel after handing over to the WiFi access network, the WiMAX handover server is triggered to perform the process of the handover from the service base station of the UE to the WiMAX handover server.

No matter which method is used for the handover from the WiMAX service base station to the WiMAX handover server, in this embodiment, the UE does not enter the idle mode of the WiMAX network after this step.

The UE may regularly or irregularly send a message, for example, a ranging message, to the WiMAX handover server through the tunnel, so that the WiMAX access network knows that the UE is in the network rather than removing the UE from the network, that is, deleting all information related to the UE and reclaiming resources occupied by the UE, because the UE cannot be found after a period of time.

The WiMAX handover server may also start a timer, so that before the timer expires, even no message from the UE is received, the UE is not removed from the network.

Step 803: When the UE decides to hand over back to the WiMAX network, after determining a handover destination base station, a process of a handover from the WiMAX handover server to the selected destination base station is performed. This process is the same as Step 6 shown in FIG. 2, except that messages between the UE and the handover server are all sent through the tunnel in the WiFi network.

Step 804: The UE tears down the tunnel between the UE and the WiMAX handover server.

Step 805: The UE turns off a WiFi RF, and turns on a WiMAX RF.

Step 806: The UE performs a ranging process and a network re-accessing process at the destination base station of the WiMAX. That is, the UE is attached to the destination base station. Once the UE is attached to the destination base station, the destination base station completes a subsequent step of the process of the handover from the handover server to the destination base station, which includes informing the handover server that the terminal is attached to the destination base station.

Step 807: The UE performs an MIP registration process.

In this way, the UE quickly hands over back to the WiMAX access network, so that a current session of a user is kept.

In view of the preceding complete handover process, in the handover method provided in this embodiment, when the UE hands over from the WiMAX access network to the WiFi access network, the attachment point of the UE in the WiMAX access network, that is the service station, is handed over from the current service base station to the WiMAX handover server, so that the UE is still in a networked state in the WiMAX access network, that is, the context information of the UE is kept. When the UE hands over from the WiFi access network back to the WiMAX access network, processes such as pre-authentication and key distribution of the WiMAX access network do not need to be performed again for performing the process of the handover from the WiMAX handover server to the destination base station, the steps are less, and the time is saved, so that after handing over from the WiMAX access network to the WiFi access network, a multi-mode UE in a single RF handover mode is capable of quickly handing over back to the original WiMAX access network. That the context of the UE in the WiMAX network is kept during the handover from the WiMAX to the WiFi is taken only an example for description. Persons skilled in the art may obtain an implementation method for keeping the context of the UE in the WiFi network during the handover from the WiFi to the WiMAX according to the preceding description, which is not described herein again.

Persons skilled in the art may also obtain a technical solution to keep the context of UE in one network when the UE hands over to another network according to the preceding embodiments, for a handover between networks other than the WiMAX network and the WiFi network, which is not described herein again.

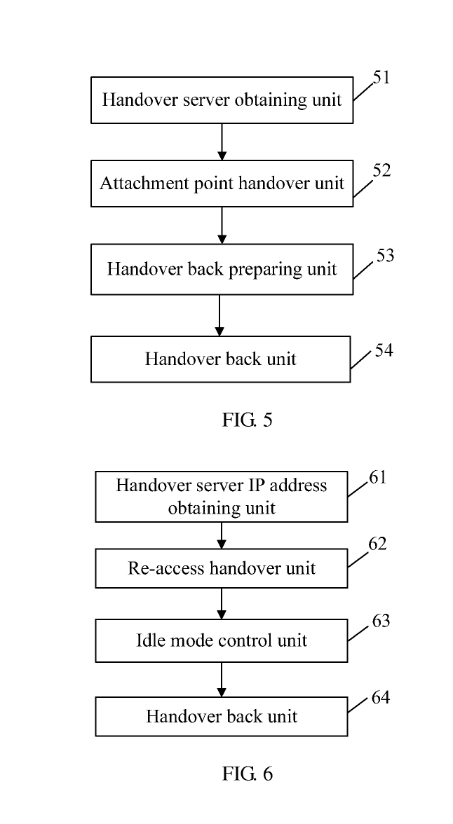

Referring to FIG. 5, based on the embodiments of the handover methods shown in FIG. 1 and FIG. 2, an embodiment of the present invention provides a handover device, including:

a handover server obtaining unit 51, configured to obtain an address of a handover server of a first access network when a UE hands over from the first access network to a second access network;

an attachment point handover unit 52, configured to hand over an attachment point of the UE from a service station of the first access network to the handover server of the first access network;

a handover back preparing unit 53, configured to establish a tunnel with the handover server of the first access network after the UE completes network access at a second AP, interact with the handover server of the first access network through the tunnel, perform attachment to the handover server of the first access network, and enter an idle mode of the first access network; and

a handover back unit 54, configured to perform attachment to a destination station of the first access network to quit the idle mode and re-access the first access network when the UE hands over from the second access network back to the first access network.

When the first access network is a WiMAX access network, the attachment point handover unit 52 is specifically configured to enable the UE to send a handover request message to a WiMAX service base station, so that the WiMAX service base station exchanges handover-related information with a WiMAX handover server; receive a handover response message that is returned by the WiMAX service base station; and enable the UE to send a handover indication message to the WiMAX service base station according to the handover response message, so that the WiMAX service base station sends a handover confirmation message to the WiMAX handover server.

When the UE works in the second access network, in order to keep an idle mode of the first access network, a message needs to be regularly sent to the WiMAX handover server through the tunnel.

Therefore, the handover back preparing unit 53 is further configured to enable the UE to regularly send the message to the handover server of the first access network through the tunnel established with the handover server of the first access network to keep the idle mode.

The handover back unit 54 is specifically configured to enable the UE to select the destination station of the first access network; tear down the tunnel between the UE and the handover server of the first access network; turn off an RF of the second access network, and turn on an RF of the first access network; and perform a process of network re-accessing at the destination station of the first access network.

The preceding handover device may be a part of a function of the UE, and disposed in the UE.

The handover device provided in this embodiment of the present invention obtains the address of the handover server of the first access network through the handover server obtaining unit 51 when the handover from the first access network to the second access network is performed. Before the UE hands over to the second access network, the attachment point handover unit 52 hands over the attachment point of the UE from the service station of the first access network to the handover server of the first access network. Therefore, when the UE hands over to the second access network, the first access network still keeps context information of the UE. When the UE is required to hand over from the second access network back to the first access network, the handover back preparing unit 53 may directly establish the tunnel with the handover server of the first access network, interact with the handover server of the first access network through the tunnel, perform attachment to the handover server of the first access network, and enter the idle mode of the first access network. Then, the handover back unit 54 performs attachment to the destination station of the first access network to quit the idle mode and re-access the first access network. Compared with the prior art, processes such as pre-authentication and key distribution of the first access network do not need to be performed again, and the steps are less, so that after handing over from the first access network to the second access network, a multi-mode UE in a single RF handover mode is capable of quickly handing over back to the original first access network.

Referring to FIG. 6, based on the embodiments of the handover methods shown in FIG. 3 and FIG. 4, an embodiment of the present invention provides another handover device, including:

a handover server IP address obtaining unit 61, configured to obtain an address of a handover server of a first access network before or after a UE hands over from the first access network to a second access network;

a re-access handover unit 62, configured to establish a tunnel with the handover server of the first access network after the UE hands over from the first access network to the second access network, re-access the first access network from the handover server of the first access network through the tunnel, and trigger the first access network to hand over an attachment point of the UE from a service station of the first access network to the handover server of the first access network;

an idle mode control unit 63, configured to interact with the handover server of the first access network through the tunnel, and enter an idle mode of the first access network, after the UE completes the handover from the service station of the first access network to the handover server of the first access network through the tunnel; and

a handover back unit 64, configured to perform attachment to a destination station of the first access network to quit the idle mode and re-access the first access network when the UE hands over from the second access network back to the first access network.

When the first access network is a WiMAX access network, the getting access to, by re-access handover unit 62, the first access network from the handover server of the first access network through the tunnel, and triggering the first access network to hand over the attachment point of the UE from the service station of the first access network to the handover server of the first access network specifically includes:

sending a ranging request message to the handover server of the first access network, where the ranging request message includes identification information of the service station of the equipment; and

receiving a ranging response message sent by the handover server of the first access network.

When the UE works in the second access network, in order to keep the idle mode of the first access network, a message needs to be regularly sent to the handover server of the first access network through the tunnel.

Therefore, the idle mode control unit 63 is further configured to regularly send the message to the handover server of the first access network through the tunnel established with the handover server of the first access network to keep the idle mode.

The handover back unit 64 may be specifically configured to select the destination station of the first access network; tear down the tunnel between the UE and the handover server of the first access network; turn off an RF of the second access network, and turn on an RF of the first access network; and perform a process of network re-accessing at the destination station of the first access network.

The preceding handover device may be a part of a function of UE, and disposed in the UE.

The handover device provided in this embodiment of the present invention obtains the IP address of the handover server of the first access network through the handover server obtaining unit 61 before or after the handover from the first access network to the second access network. After the UE hands over to the second access network, the re-access handover unit 62 establishes the tunnel between the UE and the handover server of the first access network, re-access the first access network through the tunnel, and hands over the attachment point of the UE from the service station of the first access network to the handover server of the first access network. Then, the idle mode control unit 63 interacts with the handover server of the first access network, and enters the idle mode of the first access network. The handover back unit 64 performs attachment to the destination station of the first access network to quit the idle mode and re-access the first access network. Compared with the prior art, processes such as pre-authentication and key distribution of the first access network do not need to be performed again, and the steps are less, so that after handing over from the first access network to the second access network, a multi-mode UE in a single RF handover mode is capable of quickly handing over back to the original first access network.

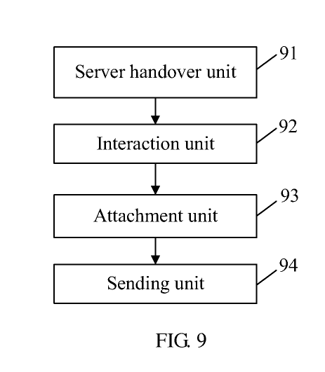

As shown in FIG. 9, an embodiment of a third handover device according to the present invention includes the following units:

a server handover unit 91, configured to hand over a service station of a first access network of a UE from a current service station to a handover server of the first access network when the UE hands over from the first access network to a second access network;

an interaction unit 92, configured to interact with the handover server of the first access network through a tunnel in the second access network before the UE hands over from the second access network back to the first access network, so that a handover, in the first access network, from the handover server to a destination station of the UE is performed; and

an attachment unit 93, configured to enable the UE to perform attachment to the destination station of the first access network, and complete the handover from the handover server of the first access network to the destination station.

As shown in FIG. 9, the handover device may further include:

a sending unit 94, configured to regularly or irregularly send a message to the handover server of the first access network through the tunnel to keep a networked state of the UE in the first access network.

The implementation of the preceding units is already described in the descriptions of the foregoing methods, and is not described herein again.

According to the embodiment of the present invention, during the handover of the UE from the first access network to the second access network, the service station of the first network of the UE is handed over from the current service station to the handover server of the first access network. Before handing over from the second access network back to the first access network, the UE interacts with the handover server of the first access network through the tunnel, and performs the handover, in the first access network, from the handover server to the destination station of the UE. The UE performs attachment to the destination station of the first access network, and completes the handover from the handover server of the first access network to the destination station. Therefore, when the UE hands over to the second access network, the first access network still keeps context information of the UE. When being required to hand over from the second access network back to the first access network, the UE hands over from the handover server of the first access network to the destination station through the tunnel, thereby completing the process of the handover back to the first access network. Compared with the prior art, processes such as pre-authentication and key distribution of the first access network do not need to be performed again, and the steps are less, so that after handing over from the first access network to the second access network, a multi-mode UE in a single RF handover mode is capable of quickly handing over back to the original first access network.

Persons skilled in the art may realize that the units in each of the illustrative examples and the implementation steps described with reference to the embodiments of the present invention may be implemented by electronic hardware, computer software, or combined electronic hardware and computer software. To clearly describe interchangeability of the hardware and the software, the preceding generally describes composition and steps of each example according to functions. Whether the functions are executed by hardware or software depends on specific applications of the technical solutions and design constraints. For each specific application, persons skilled in the art may use various methods to implement the described functions, but it should be understood that the implementation does not exceed the scope of the present invention.

The steps of the methods according to the embodiments of the present invention may be implemented by hardware, a software module executed by a processor, or the hardware and the software module executed by the processor in combination. The software module may be disposed in a Random Access Memory (RAM), a memory, a Read-Only Memory (ROM), a computer programmable ROM, a computer erasable programmable ROM, a register, a hard disk, a movable hard disk, a Compact Disc (CD)-ROM, or any other storage medium.

The preceding specific embodiments are not intended to limit the present invention. Any modification, equivalent replacement, and improvement without departing from the principle of the present invention shall fall within the protection scope of the present invention.

1. A handover method, comprising:
obtaining, by a user equipment, an IP address of a handover server of a first access network;
being handed over, by the user equipment, from the first access network to a second access network;
after handing over to the second access network, establishing, by the user equipment, an IP tunnel with the handover server of the first access network, interacting with the handover server of the first access network through the tunnel, and performing a handover, in the first access network, from a service station of the user equipment to the handover server;
entering, by the user equipment, an idle mode of the first access network from the handover server through the tunnel; and
performing, by the user equipment, attachment to a destination station of the first access network to quit the idle mode and re-access the first access network when handing over from the second access network back to the first access network.

2. The handover method according to claim 1, wherein obtaining the IP address of the handover server of the first access network comprises:
obtaining the IP address of the handover server of the first access network before the user equipment hands over from the first access network to the second access network; and
obtaining the IP address of the handover server of the first access network after the user equipment hands over from the first access network to the second access network.

3. The handover method according to claim 1, wherein when the first access network is a WiMAX access network and wherein the interacting with the handover server of the first access network through the tunnel and performing the handover from the service station of the user equipment to the handover server comprises:
sending, by the user equipment, a ranging request message to the handover server of the first access network through the tunnel, wherein the ranging request message comprises identification information of the service station of the user equipment;
obtaining, by the handover server of the first access network, context information of the user equipment at least from the service station of the user equipment after receiving the ranging request, and establishing a data path for the user equipment;
sending, by handover server of the first access network, a ranging response message to the user equipment; and
interacting, by the handover server of the first access network, with the service station of the user equipment to confirm completion of the handover.

4. The handover method according to claim 1, wherein after the entering the idle mode, the method further comprises:
regularly sending, by the user equipment, a message to the handover server of the first access network through the tunnel to keep the idle mode.

5. The handover method according to claim 1, wherein when the first access network is a Worldwide Interoperability for Microwave Access (WiMAX) access network and when the user equipment hands over from the second access network back to the first access network, performing attachment to the destination station of the first access network to quit the idle mode and re-access the first access network comprises:
selecting, by the user equipment, the destination station of the first access network;
tearing down the tunnel between the user equipment and the handover server of the first access network;
turning off a radio frequency of the second access network;
turning on a radio frequency of the first access network; and
performing a ranging process at the destination station of the first access network to quit the idle mode.

6. A handover device, comprising:
a handover server IP address obtaining unit, configured to obtain an IP address of a handover server of a first access network before or after a user equipment hands over from the first access network to a second access network;
a re-access handover unit, configured to, after the user equipment hands over from the first access network to the second access network, establish an IP tunnel with the handover server of the first access network, to re-access the first access network from the handover server of the first access network through the tunnel, and to trigger the first access network to hand over an attachment point of the user equipment from a service station of the first access network to the handover server of the first access network;
an idle mode control unit, configured to, after the user equipment completes the handover, interact with the handover server of the first access network through the tunnel from the service station of the first access network to the handover server of the first access network through the tunnel, and enter an idle mode of the first access network; and
a handover back unit, configured to perform attachment to a destination station of the first access network to quit the idle mode and re-access the first access network when the user equipment hands over from the second access network back to the first access network.

7. The handover device according to claim 6, wherein when the first access network is a Worldwide Interoperability for Microwave Access (WiMAX) access network and wherein the re-access handover unit is specifically configured to send a ranging request message to the server of the first access network to trigger the handover server of the first access network to hand over the user equipment from the service station of the user equipment to the handover server; and to receive a ranging response message from the handover server of the first access network.

8. The handover device according to claim 6, wherein the idle mode control unit is further configured to regularly send a message to the handover server of the first access network through the tunnel established with the handover server of the first access network to keep the idle mode.

9. The handover device according to claim 6, wherein the handover back unit is specifically configured to enable the user equipment to select the destination station of the first access network; to tear down the tunnel between the user equipment and the handover server of the first access network; to turn off a radio frequency of the second access network; to turn on a radio frequency of the first access network; and to perform a ranging process at the destination station of the first access network to quit the idle mode.

10. The handover device according to claim 6, wherein the handover device is disposed in the user equipment.

11. A handover method, comprising:
handing over a service station of a first access network of a user equipment from a current service station to a handover server of the first access network when the user equipment hands over from the first access network to a second access network;
interacting with the handover server of the first access network through a tunnel in the second access network to perform a handover, in the first access network, from the handover server to a destination station of the user equipment before the user equipment hands over from the second access network back to the first access network; and
performing, by the user equipment, attachment to the destination station of the first access network, and completing the handover from the handover server of the first access network to the destination station.

12. The handover method according to claim 11, wherein before the user equipment hands over from the second access network back to the first access network and wherein the method further comprises:
regularly or irregularly sending, by the user equipment, a message to the handover server of the first access network through the tunnel to keep a networked state of the user equipment in the first access network.

13. The handover method according to claim 11, wherein after the handing over the service station of the first access network of the user equipment from the current service station to the handover server of the first access network, the method further comprises:
starting, by the first access network, a timer, so that a networked state of the user equipment is kept before the timer expires.

14. A handover device, comprising:
a server handover unit, configured to hand over a service station of a first access network of a user equipment from a current service station to a handover server of the first access network when the user equipment hands over from the first access network to a second access network;
an interaction unit, configured to interact with the handover server of the first access network through a tunnel in the second access network before the user equipment hands over from the second access network back to the first access network, so that a handover, in the first access network, from the handover server to a destination station of the user equipment is performed; and
an attachment unit, configured to enable the user equipment to perform attachment to a destination station of the first access network, and complete the handover from the handover server of the first access network to the destination station.

15. The handover device according to claim 14, further comprising:
a sending unit, configured to regularly or irregularly send a message to the handover server of the first access network through the tunnel to keep a networked state of the user equipment in the first access network.

16. The handover method according to claim 1, wherein the user equipment is handed over from the first access network to the second access network before the IP address of the handover server of the first access network is obtained.

17. The handover method according to claim 1, wherein the user equipment is handed over from the first access network to the second access network after the IP address of the handover server of the first access network is obtained.
